(19) United States
(12) Patent Application Publication
(10) Pub. No.: US 2023/0030522 A1
(43) Pub. Date: Feb. 2, 2023

(54) VIBRATION PROCESSING APPARATUS, VIBRATION PROCESSING METHOD, AND NON-TRANSITORY STORAGE MEDIUM

(71) Applicant: NEC Corporation, Minato-ku, Tokyo (JP)

(72) Inventors: Yasuharu ONISHI, Tokyo (JP); Yasuyuki FUKUTA, Tokyo (JP); Sae WATANABE, Tokyo (JP); Noboru TASHIRO, Tokyo (JP); Michio SHIBATA, Tokyo (JP)

(73) Assignee: NEC Corporation, Minato-ku, Tokyo (JP)

(21) Appl. No.: 17/790,554

(22) PCT Filed: Dec. 22, 2020
(86) PCT No.: PCT/JP2020/048039

§ 371 Date: Jul. 1, 2022

(30) Foreign Application Priority Data
Jan. 8, 2020 (JP) 2020-001362

(51) Int. Cl. B65G 43/00; G01M 13/023

(52) U.S. Cl. CPC B65G 43/00; G01M 13/023; B65G 2203/042

(57) ABSTRACT

A vibration processing apparatus (10) includes a vibration information acquisition unit (110), a reference region setting unit (120), and a determination unit (130). The vibration information acquisition unit (110) acquires detection data indicating a detection result of a vibration sensor (222). The vibration information acquisition unit (110) generates vibration information by processing the detection data. The vibration information indicates magnitude of amplitude by frequency. The reference region setting unit (120) generates data indicating a reference region set in the vibration information. The reference region indicates, by frequency, a range of amplitude in which a belt conveyor (20) is determined to be normal. When amplitude is outside the reference region at any frequency in the vibration information generated at a certain timing, the determination unit (130) determines that an abnormality occurs in a monitoring target at the timing.

### TECHNICAL FIELD

The present invention relates to a vibration processing apparatus, a vibration processing method, and a program.

### BACKGROUND ART

There is a method using a vibration or an acoustic sensor for monitoring a facility. For example, a manufacturing loss is avoided by acquiring vibration data generated by a processing machine during processing of a production material and stopping the processing of the production material when an abnormal vibration is captured. Patent Document 1 discloses a method of attaching a sensor to a facility being a monitoring target, and monitoring the facility, based on time-series data measured by the sensor.

### RELATED DOCUMENT

### Patent Document

[Patent Document 1] Japanese Patent Application Publication No. 2009-270843

### SUMMARY OF THE INVENTION

### Technical Problem

The present inventor has considered a new technique for accurately determining whether an abnormality occurs in a monitoring target. One example of an object of the present invention is to accurately determine whether an abnormality occurs in a monitoring target.

### Solution to Problem

The present invention provides a vibration processing apparatus including: a vibration information acquisition means for acquiring vibration information that is a result of detecting a vibration generated in a monitoring target and indicates magnitude of amplitude by frequency;

a reference region setting means for processing a plurality of pieces of the vibration information generated at timings different from each other in a state where an abnormality does not occur in the monitoring target, and setting, by frequency, a reference region for amplitude for determining that the monitoring target is normal, by using a result of the processing; and

a determination means for determining that an abnormality occurs in the monitoring target at a first timing when amplitude is outside the reference region at any frequency in the vibration information generated at the first timing.

The present invention provides a vibration processing method including:

by a computer,

acquiring vibration information that is a result of detecting a vibration generated in a monitoring target and indicates magnitude of amplitude by frequency;

processing a plurality of pieces of the vibration information generated at timings different from each other in a state where an abnormality does not occur in the monitoring target, and setting, by frequency, a reference region for amplitude for determining that the monitoring target is normal, by using a result of the processing; and

determining that an abnormality occurs in the monitoring target at a first timing when amplitude is outside the reference region at any frequency in the vibration information generated at the first timing.

The present invention provides a program causing a computer to include:

a function of acquiring vibration information that is a result of detecting a vibration generated in a monitoring target and indicates magnitude of amplitude by frequency;

a function of processing a plurality of pieces of the vibration information generated at timings different from each other in a state where an abnormality does not occur in the monitoring target, and setting, by frequency, a reference region for amplitude for determining that the monitoring target is normal, by using a result of the processing; and

a function of determining that an abnormality occurs in the monitoring target at a first timing when amplitude is outside the reference region at any frequency in the vibration information generated at the first timing.

### Advantageous Effects of Invention

According to the present invention, whether an abnormality occurs in a monitoring target can be accurately determined.

### BRIEF DESCRIPTION OF THE DRAWINGS

FIG. 1 is diagram for describing a usage environment of a vibration processing apparatus according to an example embodiment.

FIG. 2 is a diagram illustrating one example of a functional configuration of the vibration processing apparatus.

FIG. 3 is a diagram for describing one example of a reference region.

FIG. 4 is a diagram illustrating a hardware configuration example of the vibration processing apparatus.

FIG. 5 is a flowchart illustrating one example of processing performed by a reference region setting unit of the vibration processing apparatus.

FIG. 6 is a flowchart illustrating one example of processing performed by a determination unit of the vibration processing apparatus.

### DESCRIPTION OF EMBODIMENTS

Hereinafter, example embodiments of the present invention will be described with reference to the drawings. Note that, in all of the drawings, a similar component has a similar reference sign, and description thereof will be appropriately omitted.

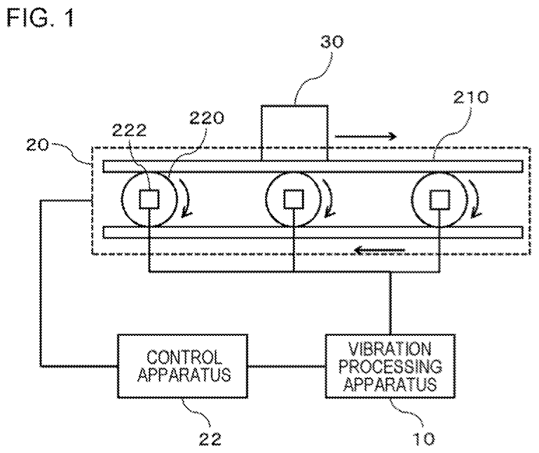

FIG. 1 is diagram for describing a usage environment of a vibration processing apparatus according to an example embodiment. The vibration processing apparatus 10 according to the example embodiment processes a vibration generated in a monitoring target, and thus detects and/or predicts an abnormality in the monitoring target. The monitoring target is a facility provided at a factory and the like. In the following description, the monitoring target is assumed to be a belt conveyor 20. The belt conveyor 20 conveys coal, coke, or the like at an iron mill or a power plant, for example. Further, when the belt conveyor 20 is installed at an iron mill, the belt conveyor 20 may convey ironstone.

At least one vibration sensor 222 is attached to the belt conveyor 20. In the example illustrated in this figure, the belt conveyor 20 includes a plurality of rotating shafts 220. The vibration sensor 222 detects a vibration generated in a belt 210 or the rotating shaft of the belt conveyor 20. In the example illustrated in this figure, the vibration sensor 222 is attached to each of or the vicinity of the plurality of rotating shafts 220. However, the vibration sensor 222 may also be attached to another portion of the belt conveyor 20.

As an abnormality occurring in the belt conveyor 20, there are a partial rupture of the belt 210, a fall of a conveyed object 30, an abnormality in the rotating shaft 220, and the like. Then, when the abnormalities occur or the abnormalities are about to occur, a vibration different from a normal vibration is generated in the belt 210 or the rotating shaft 220. The vibration processing apparatus 10 processes the vibration detected by the vibration sensor 222, and thus detects the abnormality or predicts an occurrence of the abnormality.

Note that, the belt conveyor 20 is controlled by a control apparatus 22. The vibration processing apparatus 10 acquires control information about the belt conveyor 20 from the control apparatus 22, and detects and/or predicts an abnormality by using the control information.

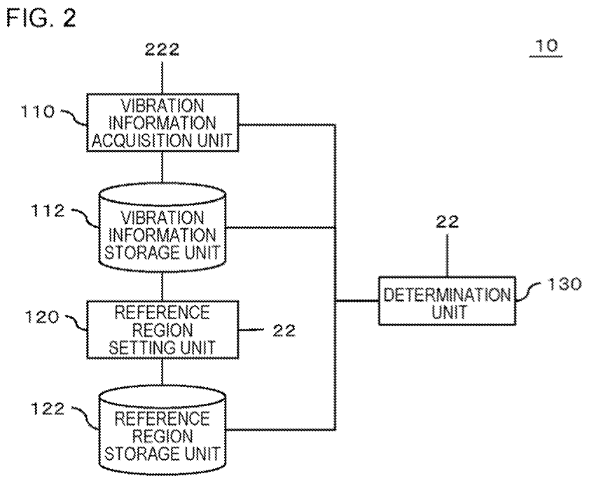

FIG. 2 is a diagram illustrating one example of a functional configuration of the vibration processing apparatus 10. In the example illustrated in this figure, the vibration processing apparatus 10 includes a vibration information acquisition unit 110, a reference region setting unit 120, and a determination unit 130.

The vibration information acquisition unit 110 acquires detection data indicating a detection result of the vibration sensor 222 in association with a detection timing (for example, information indicating detection year, month, and day, and a time) of the detection data. Then, the vibration information acquisition unit 110 generates vibration information by processing the detection data. The vibration information indicates magnitude of amplitude by frequency.

The reference region setting unit 120 generates data indicating a reference region set for the vibration information. The reference region indicates, by frequency, a range of amplitude in which the belt conveyor 20 is determined to be normal. For example, the reference region setting unit 120 processes a plurality of pieces of vibration information generated at timings different from each other in a state where an abnormality does not occur in the belt conveyor 20, and sets a reference region by using a result of the processing. The processing performed herein is, for example, statistical processing. A detailed example of a setting method of a reference region will be described later by using another diagram. The reference region setting unit 120 stores the set reference region in a reference region storage unit 122. The reference region storage unit 122 may be a part of the vibration processing apparatus 10, or may be located outside the vibration processing apparatus 10.

When amplitude is outside the reference region at any frequency in the vibration information generated at a certain timing, the determination unit 130 determines that an abnormality occurs in a monitoring target at the timing. The determination unit 130 repeatedly performs the processing. An interval at which the determination unit 130 performs a determination is, for example, equal to or more than one minute and equal to or less than 24 hours, but the interval is not limited in this range.

In the example illustrated in this figure, the vibration information acquisition unit 110 stores, in a vibration information storage unit 112, detection data acquired from the vibration sensor 222 and vibration information generated by the vibration sensor 222 in association with a detection timing of the detection data. The vibration information storage unit 112 may be a part of the vibration processing apparatus 10, or may be located outside the vibration processing apparatus 10.

The vibration information acquisition unit 110 may acquire detection data in real time, or may acquire detection data in a batch. The vibration information acquisition unit 110 generates the vibration information described above when the vibration information acquisition unit 110 acquires detection data, but the generation timing may be immediately after the vibration information acquisition unit 110 acquires the detection data or may be set in a batch. In the latter case, the vibration information acquisition unit 110 stores, in the vibration information storage unit 112, acquired detection data in association with a detection timing of the detection data, and reads the detection data from the vibration information storage unit 112 when vibration information is generated.

Note that, the reference region setting unit 120 may set (including updating; the same applies to description below) a reference region by a certain period of time, or may decide a setting timing of a reference region by using control information about the belt conveyor 20 being acquired from the control apparatus 22. As one example, the reference region setting unit 120 sets a reference region when the control information satisfies a setting condition. For example, when the belt conveyor 20 that has stopped starts operating, the reference region setting unit 120 may set a reference region by using vibration information after the start of operation. Further, while the belt conveyor 20 stops, the reference region setting unit 120 may set a reference region by using vibration information before the belt conveyor 20 stops. Further, when an operation condition of the belt conveyor changes, the reference region setting unit 120 may set a reference region by using vibration information after the change. The operation condition herein is, for example, at least one of a velocity of the belt 210 and weather (for example, presence or absence of rainfall or snowfall) of a place where the belt conveyor 20 is installed, which is not limited thereto. Note that, weather of a place where the belt conveyor 20 is installed may be acquired from the control apparatus 22, or may be acquired from an apparatus (for example, a server that provides weather information on the Internet) different from the control apparatus 22.

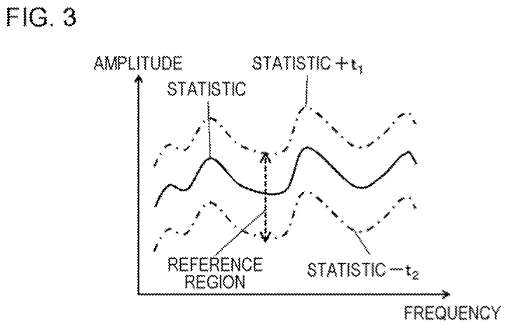

FIG. 3 is a diagram for describing one example of a reference region. In the example illustrated in this figure, the reference region setting unit 120 calculates a statistic of amplitude by frequency. The statistic is an average value, but may be a result (for example, a medium value) of other statistical processing. Then, the reference region setting unit 120 sets a reference region in such a way as to include the statistic. For example, the reference region setting unit 120 sets, as an upper limit value of the reference region, a value acquired by adding a first reference value t₁ to the statistic. Further, the reference region setting unit 120 sets, as a lower limit value of the reference region, a value acquired by subtracting a second reference value t₂ from the statistic. Herein, the first reference value t₁ and the second reference value t₂ may be the same value, or may be different values. Further, the first reference value t₁ and the second reference value t₂ may be the same value at any frequency, or may be a value at at least a part of frequency different from a value at another frequency.

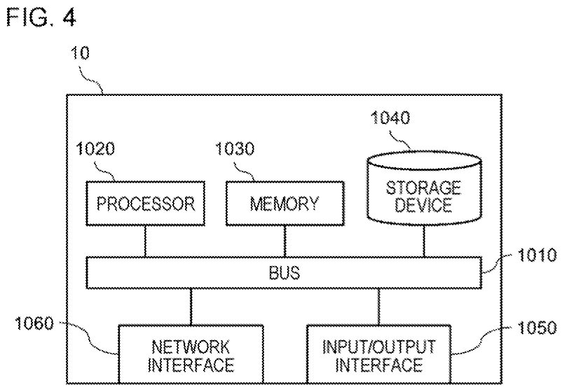

FIG. 4 is a diagram illustrating a hardware configuration example of the vibration processing apparatus 10. The vibration processing apparatus 10 includes a bus 1010, a processor 1020, a memory 1030, a storage device 1040, an input/output interface 1050, and a network interface 1060.

The bus 1010 is a data transmission path for allowing the processor 1020, the memory 1030, the storage device 1040, the input/output interface 1050, and the network interface 1060 to transmit and receive data with one another. However, a method of connecting the processor 1020 and the like to each other is not limited to bus connection.

The processor 1020 is a processor achieved by a central processing unit (CPU), a graphics processing unit (GPU), and the like.

The memory 1030 is a main storage apparatus achieved by a random access memory (RAM) and the like.

The storage device 1040 is an auxiliary storage apparatus achieved by a hard disk drive (HDD), a solid state drive (SSD), a memory card, a read only memory (ROM), or the like. The storage device 1040 stores a program module that achieves each function (for example, the vibration information acquisition unit 110, the reference region setting unit 120, and the determination unit 130) of the vibration processing apparatus 10. The processor 1020 reads each program module onto the memory 1030 and executes the program module, and each function associated with the program module is achieved. Further, the storage device 1040 also functions as the vibration information storage unit 112 and the reference region storage unit 122.

The input/output interface 1050 is an interface for connecting the vibration processing apparatus 10 and various types of input/output equipment. For example, the vibration processing apparatus 10 communicates with the control apparatus 22 and the vibration sensor 222 via the input/output interface 1050.

The network interface 1060 is an interface for connecting the vibration processing apparatus 10 to a network. The network is, for example, a local area network (LAN) and a wide area network (WAN). A method of connection to the network by the network interface 1060 may be wireless connection or wired connection. The vibration processing apparatus 10 may communicate with the control apparatus 22 and the vibration sensor 222 via the network interface 1060.

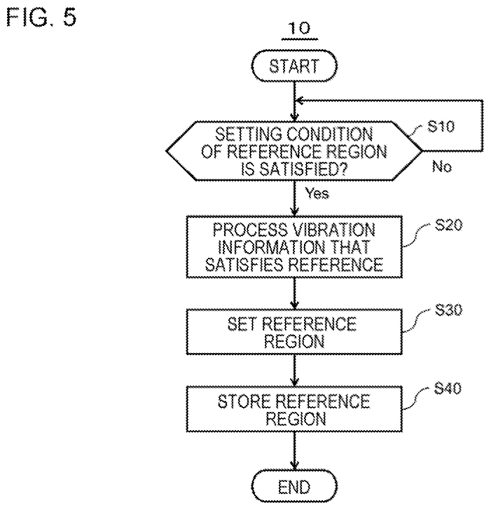

FIG. 5 is a flowchart illustrating one example of processing performed by the reference region setting unit 120 of the vibration processing apparatus 10. First, the reference region setting unit 120 determines whether a setting condition of a reference region is satisfied (step S10). A specific example of the setting condition is as described by using FIG. 2. When the setting condition is satisfied (step S10: Yes), the reference region setting unit 120 reads a plurality of pieces of vibration information that satisfy the condition from the vibration information storage unit 112, and performs processing, for example, statistical processing on the plurality of vibration conditions (step S20). Then, the reference region setting unit 120 sets the reference region by using a result of the processing (step S30), and stores information indicating the set reference region in the reference region storage unit 122 (step S40).

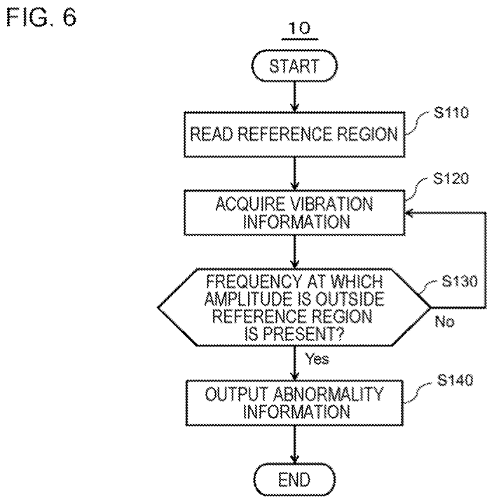

FIG. 6 is a flowchart illustrating one example of processing performed by the determination unit 130 of the vibration processing apparatus 10. First, the determination unit 130 reads information indicating a reference region from the reference region storage unit 122 (step S110). Then, every time the determination unit 130 acquires vibration information being a processing target (step S120), the determination unit 130 determines whether a frequency at which amplitude is outside the reference region is present in the vibration region (step S130). When the frequency at which amplitude is outside the reference region is present (step S130: Yes), the determination unit 130 determines that an abnormality occurs or there is a possibility that an abnormality will occur, and generates and outputs abnormality information. Herein, the determination unit 130 may output, together with the abnormality information, a detection timing associated with the vibration information being the processing target. Note that, the abnormality information is output to a terminal of a manager of the belt conveyor 20, for example. The terminal may be a fixed terminal or a portable terminal (step S140).

Note that, a frequency at which amplitude is outside a reference region may be different depending on a kind of an abnormality occurring in the belt conveyor 20. Thus, the determination unit 130 may select, by using a frequency at which amplitude is outside a reference region, information that needs to be output. For example, the reference region storage unit 122 stores each of a plurality of frequencies or frequency bands in advance in association with a kind of an abnormality associated with the frequency or the frequency band. Then, the determination unit 130 determines a frequency at which amplitude is outside a reference region, and determines a kind of an abnormality associated with the determined frequency by using the reference region storage unit 122. Then, the determination unit 130 includes, in abnormality information, information indicating the determined kind of the abnormality. Herein, the determination unit 130 may include, in the abnormality information, information indicating a method of handling the determined abnormality.

As described above, according to the present example embodiment, the reference region setting unit 120 of the vibration processing apparatus 10 processes a plurality of pieces of vibration information generated at timings different from each other in a state where an abnormality does not occur in the belt conveyor 20, and sets, by frequency, a reference region of amplitude for determining that the belt conveyor 20 is normal, by using a result of the processing. Then, when amplitude is outside the reference region at any frequency in the vibration information generated at any timing, the determination unit 130 determines that an abnormality occurs in the belt conveyor 20 at the timing. Therefore, whether an abnormality occurs in the belt conveyor 20 can be accurately determined.

While the example embodiments of the present invention have been described with reference to the drawings, the example embodiments are only exemplification of the present invention, and various configurations other than the above-described example embodiments can also be employed.

Further, the plurality of steps (pieces of processing) are described in order in the plurality of flowcharts used in the above-described description, but an execution order of steps performed in each of the example embodiments is not limited to the described order. In each of the example embodiments, an order of illustrated steps may be changed within an extent that there is no harm in context. Further, each of the example embodiments described above can be combined within an extent that a content is not inconsistent.

A part or the whole of the above-described example embodiment may also be described in supplementary notes below, which is not limited thereto.

1. A vibration processing apparatus, including:

a vibration information acquisition means for acquiring vibration information that is a result of detecting a vibration generated in a monitoring target and indicates magnitude of amplitude by frequency;

a reference region setting means for processing a plurality of pieces of the vibration information generated at timings different from each other in a state where an abnormality does not occur in the monitoring target, and setting, by frequency, a reference region for amplitude for determining that the monitoring target is normal, by using a result of the processing; and

a determination means for determining that an abnormality occurs in the monitoring target at a first timing when amplitude is outside the reference region at any frequency in the vibration information generated at the first timing.

2. The vibration processing apparatus according to supplementary note 1 described above, wherein

the processing is processing of acquiring an average value of amplitude by frequency, and

the reference region setting means sets the reference region in such a way as to include the average value.

3. The vibration processing apparatus according to supplementary note 1 or 2 described above, wherein

the monitoring target is a belt conveyor.

4. The vibration processing apparatus according to supplementary note 3 described above, wherein,

when the belt conveyor that has stopped starts operating, the reference region setting means sets the reference region by using the vibration information after the start of operation.

5. The vibration processing apparatus according to supplementary note 3 described above, wherein,

while the belt conveyor stops, the reference region setting means sets the reference region by using the vibration information before the belt conveyor stops.

6. The vibration processing apparatus according to supplementary note 3 described above, wherein,

when an operation condition of the belt conveyor changes, the reference region setting means sets the reference region by using the vibration information after the change.

7. The vibration processing apparatus according to supplementary note 6 described above, wherein

the operation condition is at least one of a velocity of the belt conveyor and weather of a place where the belt conveyor is installed.

8. The vibration processing apparatus according to any one of supplementary notes 1 to 7 described above, wherein

the determination means selects, by using a frequency at which amplitude is outside the reference region, information that needs to be output, and outputs the selected information.

9. A vibration processing method, including:

by a computer,

acquiring vibration information that is a result of detecting a vibration generated in a monitoring target and indicates magnitude of amplitude by frequency;

processing a plurality of pieces of the vibration information generated at timings different from each other in a state where an abnormality does not occur in the monitoring target, and setting, by frequency, a reference region for amplitude for determining that the monitoring target is normal, by using a result of the processing; and

determining that an abnormality occurs in the monitoring target at a first timing when amplitude is outside the reference region at any frequency in the vibration information generated at the first timing.

10. The vibration processing method according to supplementary note 9 described above, wherein

the processing is processing of acquiring an average value of amplitude by frequency,

the vibration processing method further including,

by the computer,

setting the reference region in such a way as to include the average value.

11. The vibration processing method according to supplementary note 9 or 10 described above, wherein

the monitoring target is a belt conveyor.

12. The vibration processing method according to supplementary note 11 described above, further including,

by the computer,

when the belt conveyor that has stopped starts operating, setting the reference region by using the vibration information after the start of operation.

13. The vibration processing method according to supplementary note 11 described above, further including,

by the computer,

while the belt conveyor stops, setting the reference region by using the vibration information before the belt conveyor stops.

14. The vibration processing method according to supplementary note 11 described above, further including,

by the computer,

when an operation condition of the belt conveyor changes, setting the reference region by using the vibration information after the change.

15. The vibration processing method according to supplementary note 14 described above, wherein

the operation condition is at least one of a velocity of the belt conveyor and weather of a place where the belt conveyor is installed.

16. The vibration processing method according to any one of supplementary notes 9 to 15 described above, further including,

by the computer,

selecting, by using a frequency at which amplitude is outside the reference region, information that needs to be output, and outputting the selected information.

17. A program causing a computer to include:

a function of acquiring vibration information that is a result of detecting a vibration generated in a monitoring target and indicates magnitude of amplitude by frequency;

a function of processing a plurality of pieces of the vibration information generated at timings different from each other in a state where an abnormality does not occur in the monitoring target, and setting, by frequency, a reference region for amplitude for determining that the monitoring target is normal, by using a result of the processing; and

a function of determining that an abnormality occurs in the monitoring target at a first timing when amplitude is outside the reference region at any frequency in the vibration information generated at the first timing.

18. The program according to supplementary note 17 described above, wherein

the processing is processing of acquiring an average value of amplitude by frequency,

the program further causing the computer to include

setting the reference region in such a way as to include the average value.

19. The program according to supplementary note 17 or 18 described above, wherein

the monitoring target is a belt conveyor.

20. The program according to supplementary note 19 described above, further causing the computer to include,

when the belt conveyor that has stopped starts operating, setting the reference region by using the vibration information after the start of operation.

21. The program according to supplementary note 19 described above, further causing the computer to include,

while the belt conveyor stops, setting the reference region by using the vibration information before the belt conveyor stops.

22. The program according to supplementary note 19 described above, further causing the computer to include,

when an operation condition of the belt conveyor changes, setting the reference region by using the vibration information after the change.

23. The program according to supplementary note 22 described above, wherein

the operation condition is at least one of a velocity of the belt conveyor and weather of a place where the belt conveyor is installed.

24. The program according to any one of supplementary notes 17 to 23 described above, further causing the computer to include

selecting, by using a frequency at which amplitude is outside the reference region, information that needs to be output, and outputting the selected information.

This application is based upon and claims the benefit of priority from Japanese patent application No. 2020-001362, filed on Jan. 8, 2020, the disclosure of which is incorporated herein in its entirety by reference.

### REFERENCE SIGNS LIST

10 Vibration processing apparatus
20 Belt conveyor
22 Control apparatus
30 Conveyed object
110 Vibration information acquisition unit
112 Vibration information storage unit
120 Reference region setting unit
122 Reference region storage unit
130 Determination unit
210 Belt
220 Rotating shaft
222 Vibration sensor

What is claimed is:

1. A vibration processing apparatus, comprising:
at least one memory configured to store instructions; and
at least one processor configured to execute the instructions to perform operations comprising:
acquiring vibration information that is a result of detecting a vibration generated in a monitoring target and indicates magnitude of amplitude by frequency;
processing a plurality of pieces of the vibration information generated at timings different from each other in a state where an abnormality does not occur in the monitoring target;
setting, by frequency, a reference region for amplitude for determining that the monitoring target is normal, by using a result of the processing; and
determining that an abnormality occurs in the monitoring target at a first timing when amplitude is outside the reference region at any frequency in the vibration information generated at the first timing.

2. The vibration processing apparatus according to claim 1, wherein
the processing is processing of acquiring an average value of amplitude by frequency, and
the setting a reference region comprises setting the reference region in such a way as to include the average value.

3. The vibration processing apparatus according to claim 1, wherein
the monitoring target is a belt conveyor.

4. The vibration processing apparatus according to claim 3, wherein,
the setting a reference region comprises, when the belt conveyor that has stopped starts operating, setting the reference region by using the vibration information after the start of operation.

5. The vibration processing apparatus according to claim 3, wherein,
the setting a reference region comprises, while the belt conveyor stops, setting the reference region by using the vibration information before the belt conveyor stops.

6. The vibration processing apparatus according to claim 3, wherein,
the setting a reference region comprises, when an operation condition of the belt conveyor changes, setting the reference region by using the vibration information after the change.

7. The vibration processing apparatus according to claim 6, wherein
the operation condition is at least one of a velocity of the belt conveyor and weather of a place where the belt conveyor is installed.

8. The vibration processing apparatus according to claim 1, wherein the operations further comprises:
selecting, by using a frequency at which amplitude is outside the reference region, information that needs to be output; and
outputting the selected information.

9. A vibration processing method executed by a computer, comprising:
acquiring vibration information that is a result of detecting a vibration generated in a monitoring target and indicates magnitude of amplitude by frequency;
processing a plurality of pieces of the vibration information generated at timings different from each other in a state where an abnormality does not occur in the monitoring target;
setting, by frequency, a reference region for amplitude for determining that the monitoring target is normal, by using a result of the processing; and
determining that an abnormality occurs in the monitoring target at a first timing when amplitude is outside the reference region at any frequency in the vibration information generated at the first timing.

10. The vibration processing method according to claim 9, wherein
the processing is processing of acquiring an average value of amplitude by frequency, and
the setting a reference region comprises setting the reference region in such a way as to include the average value.

11. The vibration processing method according to claim 9, wherein
the monitoring target is a belt conveyor.

12. The vibration processing method according to claim 11, wherein
the setting a reference region comprises, when the belt conveyor that has stopped starts operating, setting the reference region by using the vibration information after the start of operation.

13. The vibration processing method according to claim 11, wherein
the setting a reference region comprises, while the belt conveyor stops, setting the reference region by using the vibration information before the belt conveyor stops.

14. The vibration processing method according to claim 11, wherein
the setting a reference region comprises, when an operation condition of the belt conveyor changes, setting the reference region by using the vibration information after the change.

15. The vibration processing method according to claim 14, wherein
the operation condition is at least one of a velocity of the belt conveyor and weather of a place where the belt conveyor is installed.

16. The vibration processing method according to claim 9, further comprising:
selecting, by using a frequency at which amplitude is outside the reference region, information that needs to be output; and
outputting the selected information.

17. A non-transitory storage medium storing a program causing a computer to execute a vibration processing method, the vibration processing method comprising:
acquiring vibration information that is a result of detecting a vibration generated in a monitoring target and indicates magnitude of amplitude by frequency;
processing a plurality of pieces of the vibration information generated at timings different from each other in a state where an abnormality does not occur in the monitoring target;
setting, by frequency, a reference region for amplitude for determining that the monitoring target is normal, by using a result of the processing; and
determining that an abnormality occurs in the monitoring target at a first timing when amplitude is outside the reference region at any frequency in the vibration information generated at the first timing.

18. (canceled)

19. The non-transitory storage medium according to claim 17, wherein
the monitoring target is a belt conveyor.

20. The non-transitory storage medium according to claim 19, wherein
the setting a reference region comprises, when the belt conveyor that has stopped starts operating, setting the reference region by using the vibration information after the start of operation.

21. The non-transitory storage medium according to claim 19, wherein
the setting a reference region comprises, while the belt conveyor stops, setting the reference region by using the vibration information before the belt conveyor stops.

22.-24. (canceled)
